(19) United States
(12) Patent Application Publication
(10) Pub. No.: US 2015/0339874 A1
(43) Pub. Date: Nov. 26, 2015

(54) PAPER SHEETS PROCESSING SYSTEM AND A PAPER SHEETS PROCESSING APPARATUS

(71) Applicant: Kabushiki Kaisha Toshiba, Tokyo (JP)

(72) Inventor: Nobuyuki Kusano, Yokohama (JP)

(21) Appl. No.: 14/656,829

(22) Filed: Mar. 13, 2015

(30) Foreign Application Priority Data
May 22, 2014 (JP) 2014-106367

(51) Int. Cl. G07D 11/00; B65H 7/14; B65H 7/20

(52) U.S. Cl. CPC G07D 11/0066; B65H 7/20; B65H 7/14

(57) ABSTRACT

According to one embodiment, a paper sheets processing system includes an image acquisition unit, an event information acquisition unit, an operation unit, and an image retrieval unit. The image acquisition unit acquires a plurality of images by at least one camera scanning a predetermined position of a paper sheets processing apparatus. The at least one camera is located around the paper sheets processing apparatus. The event information acquisition unit acquires an event information related to an event occurred in the paper sheets processing apparatus. The operation unit accepts an operation indicating an event, based on the event information. The image retrieval unit retrieves at least one image corresponding to the event indicated by the operation, from the plurality of images, and outputs the at least one image.

### CROSS-REFERENCE TO RELATED APPLICATION

This application is based upon and claims the benefit of priority from Japanese Patent Application No. 2014-106367, filed on May 22, 2014; the entire contents of which are incorporated herein by reference.

### FIELD

Embodiments described herein relate generally to a paper sheets processing system and a paper sheets processing apparatus.

### BACKGROUND

A paper sheets processing apparatus for detecting fed banknotes and sorting them based on denomination thereof, is well known. Around (In a vicinity of) this paper sheets processing apparatus, a plurality of cameras to monitor the operator's injustice motion (such as carrying away the banknotes) is located. Here, if the camera is always scanning a target to be monitored, and if all scanned images are stored in a database, a person (user) must retrieve an image scanned when the irregularity occurred, from all images. This operation is very troublesome for the user.

On the other hand, another paper sheets processing apparatus is known. In this apparatus, by analyzing the scanned image, when an object (such as the operator's motion) is photographed in the scanned image, the scanned image including the object is only recorded. However, action of the paper sheets processing apparatus and the operator's operation are complicated. Accordingly, it is difficult to extract only the necessary image from all scanned images by analyzing the respective scanned images.

### BRIEF DESCRIPTION OF THE DRAWINGS

FIG. 1 is a schematic diagram of one example of a paper sheets processing apparatus 100 according to one embodiment.

FIG. 2 is a sectional plan showing an entire component of the paper sheets processing apparatus 100.

FIG. 3 is a schematic diagram showing one example of a paper sheets processing system 1 according to one embodiment.

FIG. 4 is a block diagram showing components of a central control unit 110 of the paper sheets processing system 1.

FIG. 5 is a schematic diagram showing one example of event log information 402 according to one embodiment.

FIG. 6 is a schematic diagram showing one example of a relevant information table according to one embodiment.

FIG. 7 is a flow chart of association processing by the central control unit 110 according to one embodiment.

FIG. 8 is a flow chart of retrieval processing by the central control unit 110 according to one embodiment.

### DETAILED DESCRIPTION

According to one embodiment, a paper sheets processing system includes an image acquisition unit, an event information acquisition unit, an operation unit, and an image retrieval unit. The image acquisition unit acquires a plurality of images by at least one camera scanning a predetermined position of a paper sheets processing apparatus. The at least one camera is located around the paper sheets processing apparatus. The event information acquisition unit acquires an event information related to an event occurred in the paper sheets processing apparatus. The operation unit accepts an operation indicating an event, based on the event information. The image retrieval unit retrieves at least one image corresponding to the event indicated by the operation, from the plurality of images, and outputs the at least one image.

Various embodiments will be described hereinafter with reference to the accompanying drawings.

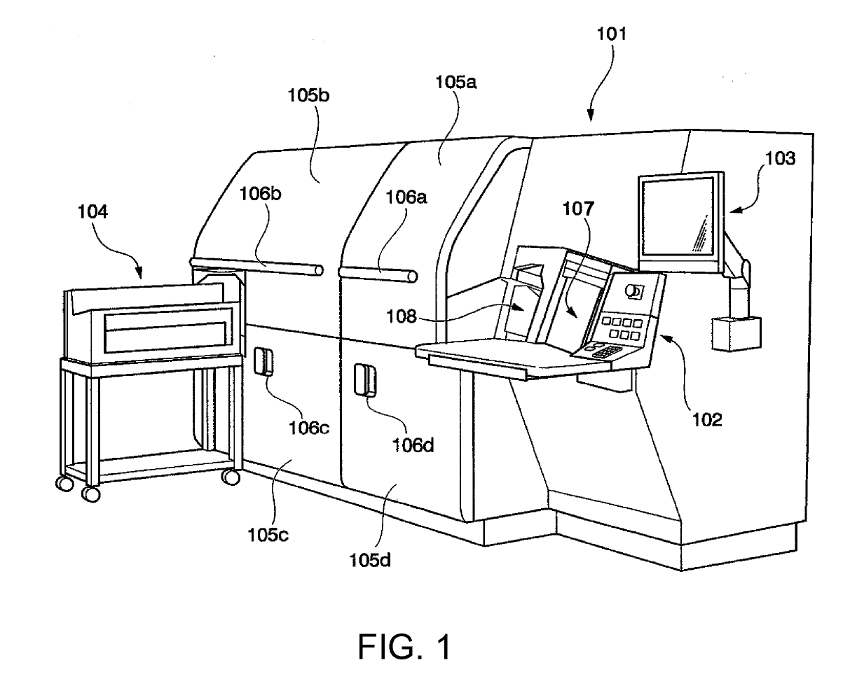

FIG. 1 is one example of a paper sheets processing apparatus 100 according to one embodiment. The paper sheets processing apparatus 100 includes a main body thereof 101, an operation unit 102, a display unit 103, and a paper sheets outlet unit 104. In the paper sheets processing apparatus 100, a side having the operation unit 102 and the display unit 103 is called a front of the paper sheets processing apparatus 100.

The front thereof is covered by a plurality of covers 105a, 105b, 105c and 105d. Handles 106a, 106b, 106c and 106d are respectively attached to the covers 105a, 105b, 105c and 105d. By opening the covers 105a˜105d, the inside of the paper sheets processing apparatus 100 is exposed.

Furthermore, in the front of the paper sheets processing apparatus 100, a feeder to set paper sheets, and a reject pocket 108 (for rejected notes) to eject predetermined paper sheets such as the rejected notes, are installed. From the outlet unit 104, a bundle of paper sheets strapped by the paper sheets processing apparatus 100 is ejected.

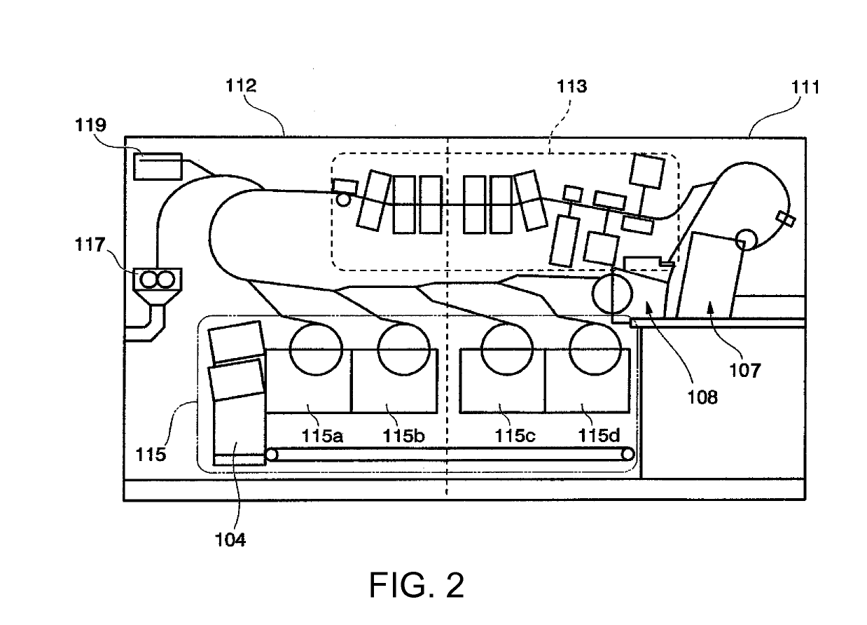

Next, by referring to FIG. 2, component of the paper sheets processing apparatus 100 is explained. FIG. 2 is a sectional plan showing an entire component of the paper sheets processing apparatus 100. The paper sheets processing apparatus 100 equips a first unit 111 and a second unit 112. The first unit 111 and the second unit 112 are connected by a transport path.

The paper sheets processing apparatus 100 includes a detection unit 113. The detection unit 113 decides a type of a banknote P being transported (supplied) from the feeder 107, and performs a fitness detection and an authority detection of the banknote P. In the paper sheets processing apparatus 100, a banknote P decided as a counterfeit note (by the authority detection of the detection unit 113), and a banknote P of which transport status is shifted from a reference posture, are collected as rejected notes and ejected from the reject pocket 108.

Furthermore, in the paper sheets processing apparatus 100, the banknote P is transported to a strapping unit 115 for each denomination decided by the detection unit 113. The strapping unit 115 straps banknotes (the number thereof is a predetermined number) for each denomination. The strapping unit 115 ejects a bundle of strapped banknotes to the outlet unit 104.

Furthermore, in the paper sheets processing apparatus 100, banknotes P decided as unfit notes (by the fitness detection of the detection unit 113) are collected and ejected to a shredding unit 117. The shredding unit 117 shreds the collected unfit notes, and ejects the shredded notes.

In the present embodiment, the detection unit 113 decides whether a paper sheet (being transported) are a banknote or a batch card. In the paper sheets processing apparatus 100, paper sheets decided as the batch card (by the detection unit 113) are ejected to a batch card outlet unit 119.

Here, the rejected note includes a note decided as the counterfeit note, a folded note, a torn note, a note of which authority cannot be decided by skew or doubled, and a batch card. The skew is a condition that the banknote P is inclined along a transport direction (i.e., the banknote P is transported with an oblique posture).

In the present embodiment, the detection unit 113 includes cameras, a physical characteristic detection means for detecting physical characteristics, or a magnetic detection means. Here, denomination detection of the banknote is processing to decide a denomination (such as 1000 yen bill, 5000 yen bill, 10000 yen bill) of the banknote based on a context printed thereon. The authority detection is processing to decide whether the banknote is a genuine note or a counterfeit note based on a reflected light from a hologram or a transparent light from a watermark of the banknote. The fitness detection is processing to decide whether the banknote is a fit note or an unfit note by deciding whether a fitness level of the banknote is higher (or lower) than a reference value based on the scanned image of the banknote. Here, the fit note is a banknote of which fitness level is lower than the reference value and which can be recirculated. The unfit note is a banknote of which fitness level is higher than the reference value and which cannot be recirculated.

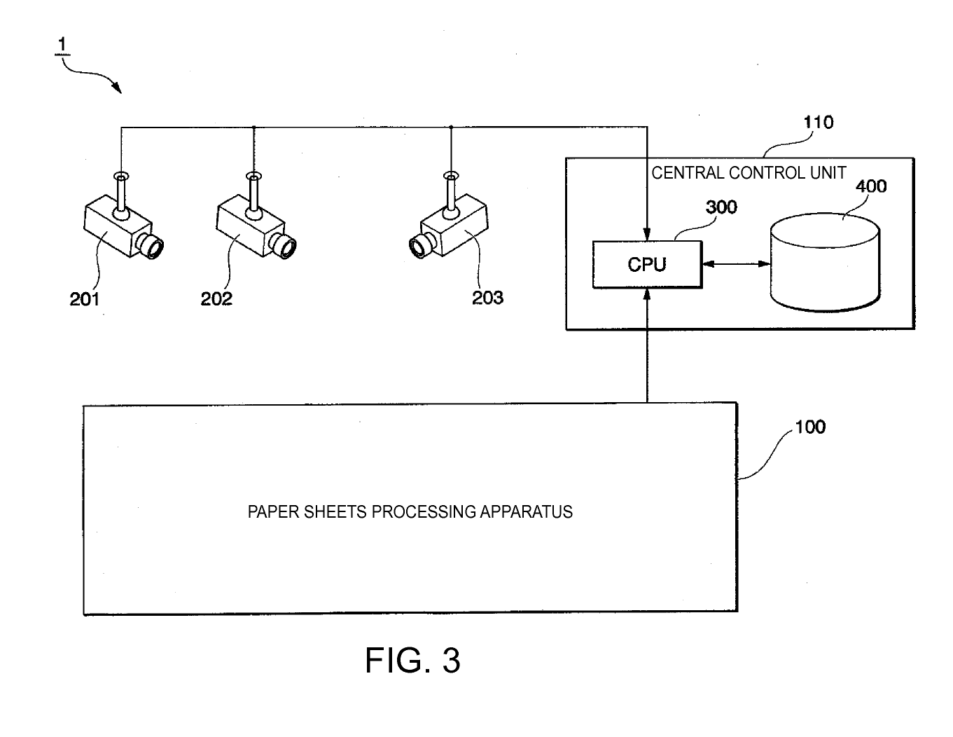

Next, by referring to FIG. 3, one example of a paper sheets processing system 1 equipping the paper sheets processing apparatus 100 is explained. FIG. 3 is a schematic diagram showing one example of the paper sheets processing system 1.

The paper sheets processing system 1 includes the paper sheets processing apparatus 100 (cash processing apparatus) and a plurality of cameras 201, 202 and 203. In the present embodiment, the main body 101 of the paper sheets processing apparatus includes a central control unit 110 connected to the plurality of cameras 201˜203. For example, the central control unit 110 includes a CPU (Central Processing Unit) 300 installed on a control board inside of the paper sheets processing apparatus 100, and a storage unit 400 that stores various data, a control program and management information. The central control unit 110 is connected to a host computer (not shown in FIG. 3) and executes information-sending/receiving or information-sorting with the host computer.

In the present embodiment, the plurality of cameras 201˜203 is respectively located around (in a vicinity of) the paper sheets processing apparatus 100, and scans a predetermined part of the paper sheets processing apparatus 100. For example, when covers 105a and 105b of the paper sheets processing apparatus 100 are opened, the camera 201 is located at a position where the inside of the paper sheets processing apparatus 100 can be scanned. Furthermore, when covers 105c and 105d of the paper sheets processing apparatus 100 are opened, the camera 202 is located at a position where the inside of the paper sheets processing apparatus 100 can be scanned. The camera 203 is located at a position where the operation unit 102, the feeder 107 and the reject pocket 108 can be scanned.

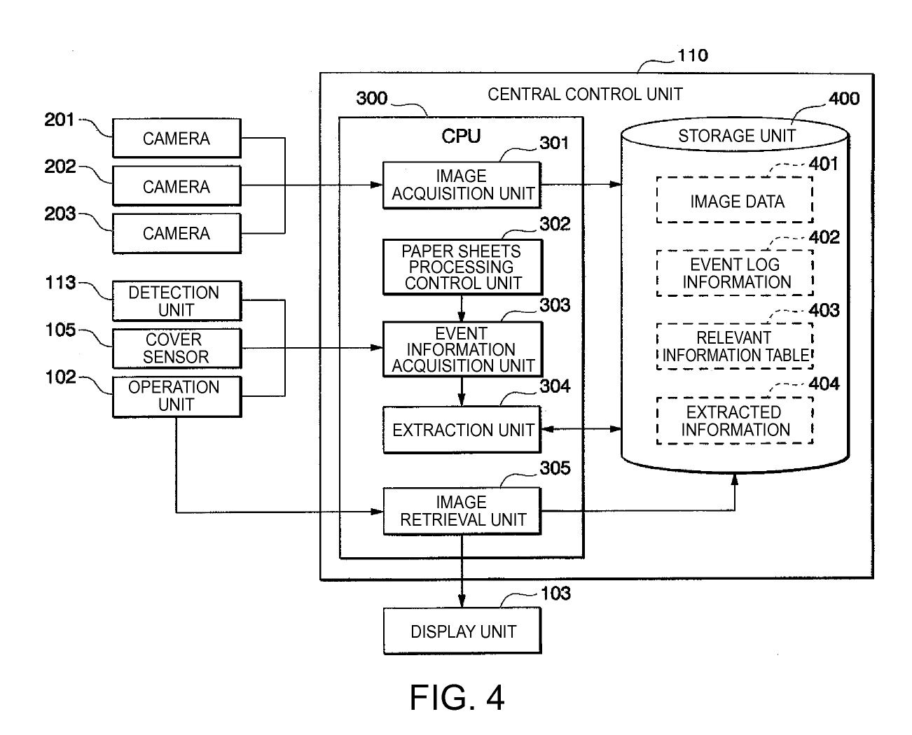

Next, by referring to FIG. 4, component of the central control unit 110 is explained. FIG. 4 is a block diagram showing a component example of the central control unit 110.

As a functional unit functioned by a CPU 300 executing a program, the central control unit 110 includes an image acquisition unit 301, a paper sheets processing control unit 302, an event information acquisition unit 303, an extraction unit 304, and an image retrieval unit 305. A part or all of these functional units may be a hardware functional unit such as LSI (Large Scale Integration) or ASIC (Application Specific Integrated Circuit). The storage unit 400 stores image data 401, event log information 402, a relevant information table 403 and extraction information 404.

the image acquisition unit 301 is connected to cameras 201˜203, and acquires images scanned by the cameras 201˜203. The image acquisition unit 301 makes the storage unit 400 store image data 401 of the acquired image.

The paper sheets processing control unit 302 controls operation of each component of the paper sheets processing apparatus 100, and makes each unit execute detection and sorting of paper sheets fed from the feeder 107.

The event information acquisition unit 303 is connected to the detection unit 113, a cover sensor 105 and the operation unit 102, and acquires event information (representing an event occurred in the paper sheets processing apparatus 100) based on outputs from each unit and the paper sheets processing control unit 302. The cover sensor 105 equips a plurality of sensors located around (in a vicinity of) covers 105a˜105d, and detects opening and closing of the covers 105a˜105d. In the present embodiment, the paper sheets processing control unit 302 generates event log information to correspond the event information representing an event (occurred) with time information when the event occurred, and outputs the event log information to the event information acquisition unit 303. The event information acquisition unit 303 makes the storage unit 400 store the event log information (from the paper sheets processing control unit 302).

Based on the image data 401 stored in the storage unit 400, the extraction unit 304 extracts an image related to the event from a plurality of images (acquired by the image acquisition unit 301), generates extracted information 404 to associate the extracted image with the event information, and makes the storage unit 400 store the extracted information 404. The extraction unit 304 deletes images except for the extracted image from the image data 401 stored in the storage unit 400.

By referring to the storage unit 400, the image retrieval unit 305 retrieves images corresponding to an event indicated via the operation unit 102. The image retrieval unit 305 makes the display unit 103 output the retrieval result.

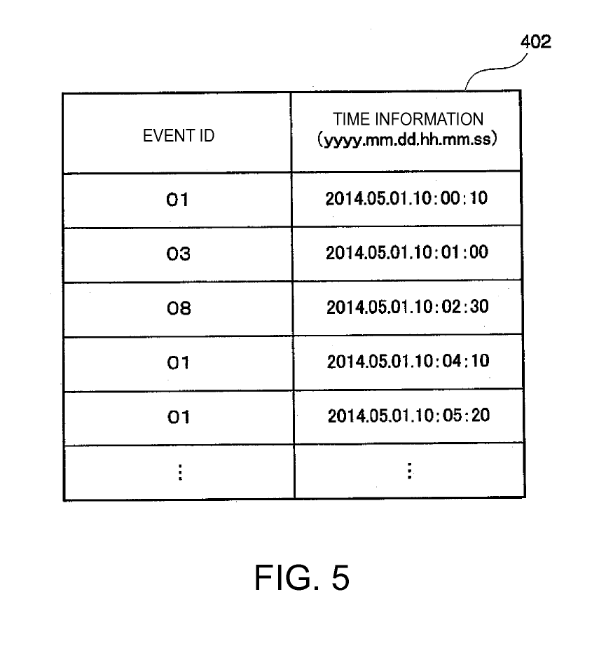

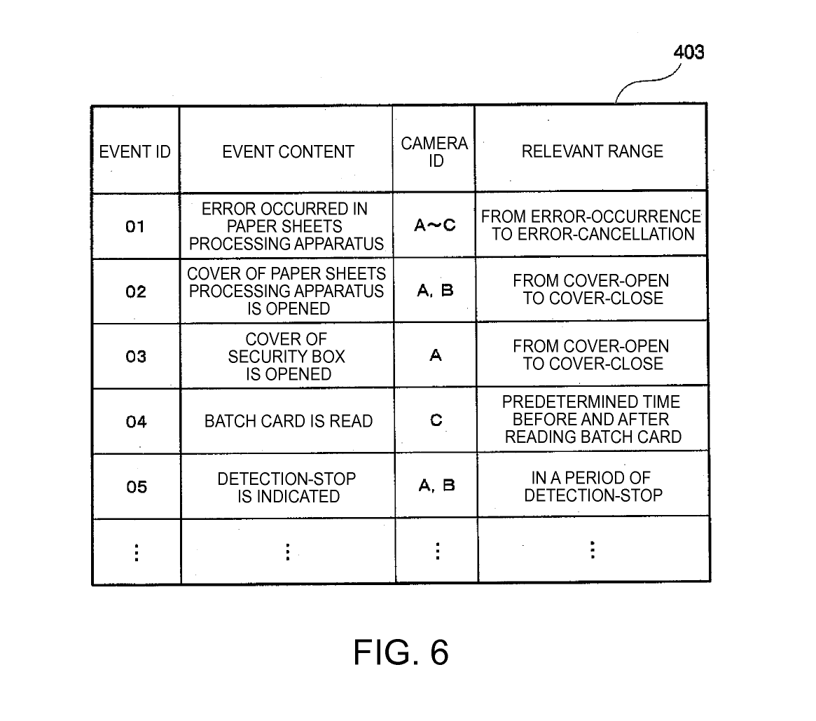

Next, by referring to FIGS. 5 and 6, information stored in the storage unit 400 is explained. The image data 401 are data of an image scanned by the cameras 201˜203. In the present invention, the image data 401 compose a video by a plurality of continuous images. In each image datum, attached information is linked. The attached information includes time information representing a date and a time when the image is scanned and camera information (Hereinafter, a camera ID) representing the camera which has scanned the image.

The extracted information 404 includes image data of the image (extracted by the extraction unit 304) and an event ID corresponding to the extracted image.

FIG. 5 shows one example of event log information 402. In the event log information 402, identification information (Hereinafter, it is called an event ID) to identify each event, and time information representing a date and a time when the event has occurred, are corresponded. The event ID corresponding to each event is previously determined.

FIG. 6 shows one example of a relevant information table 403. In the relevant information table 403, the event ID, an event content, a camera ID, and a relevant range, are corresponded. The camera ID is a content of the event to which each event ID is assigned. The camera ID is an identifier representing a camera corresponding to the event. Here, the camera ID “A” corresponds to the camera 201, the camera ID “B” corresponds to the camera 202, and the camera ID “C” corresponds to the camera 203. The relevant range is information representing a range of a video corresponding to the event. In the present embodiment, as the relevant range, on the basis of occurrence timing of each event, a period based on a type of the event is prescribed. For example, a start timing and an end timing of the video corresponding to the event, and a duration including the occurrence timing of the event, are defined.

Here, by referring to FIG. 6, a concrete example of the event is explained. The event of event ID “01” represents that error of the paper sheets processing apparatus 100 has occurred. As the error of the paper sheets processing apparatus 100, an error of the shredding unit 117, a paper jam of the transport path, and a shortage of webbings in the strapping unit 115, are included. In this case, covers 105a˜105d may be opened, or the operation unit 102 may be operated. Accordingly, in a period from an occurrence timing of an error to a cancellation timing of the error, images scanned by the cameras 201˜203 are regarded as the relevant range. By checking these images, it can be confirmed whether the covers 105a˜105d are opened/closed when the error has occurred, and whether the operator illegally operates.

The event of event ID “02” represents that the covers 105a˜105d are opened. In this case, in a period from a timing when any of the covers 105a˜105d is opened to a timing when the cover is closed, images by the cameras 201 and 202 scanning the operator's hand operating the inside of the covers 105a˜105d are regarded as the relevant range. By checking these images, it can be confirmed whether the covers 105a˜105d are illegally opened/closed when the error has occurred.

The event ID “03” represents that a cover (not shown in FIG. 2) of a security box of the shredding unit 117 is opened. The security box of the shredding unit 117 is an area that banknotes should not be remained before shredding or after shredding. In this case, in a period from a timing when the security box of the shredding unit 117 is opened to a timing when the security box is closed, images by the camera 201 scanning the operator's hand operating the neighborhood of the security box are regarded as the relevant range. By checking these images, it can be confirmed whether the operator illegally operates the shredding unit 117.

The event ID “04” represents that a batch card is read in each processing such as pre-processing, detection processing and RS processing (processing of rejected notes). In this case, in a period before and after the batch card is read, images by the camera 203 scanning the operator's hand putting into the feeder 107 are regarded as the relevant range. By checking these images, the batch operation can be confirmed when overs and shorts has occurred in each unit delimited by the batch card.

The event ID “05” represents that detection-stop is indicated. In this case, in a period of the detection-stop, images by the cameras 201 and 202 scanning the operator's hand operating the inside of the covers 105a˜105d are regarded as the relevant range. By checking these images, when authority detection is stopped, it can be confirmed whether injustice (for example, banknotes are replaced with white papers) has occurred.

In this way, based on a type of the event, the relevant range of the images can be determined, i.e., a video after the event has occurred is only regarded as the relevant range, or videos before and after the event has occurred are regarded as the relevant range. Furthermore, duration of a period of the relevant range can be set for each event.

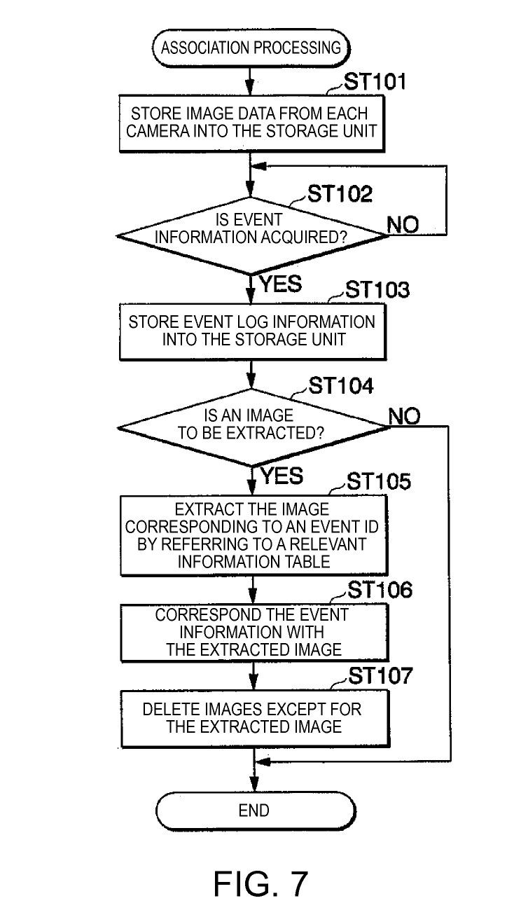

Next, by referring to FIG. 7, association processing by the central control unit 110 is explained. FIG. 7 is a flow chart of one example of the association processing by the central control unit 110. Here, based on an indication from the operation unit 102, the paper sheets processing control unit 302 starts and controls operation of the paper sheets processing apparatus 100.

The image acquisition unit 301 acquires image data of images scanned by the cameras 201˜203, and stores the images into the storage unit 400 (ST101). The event information acquisition unit 303 decides whether event information is acquired or not (ST102). If the event has occurred in the paper sheets processing apparatus 100, the event information acquisition unit 303 acquires event log information from the paper sheets processing unit 302, and stores the event log information into the storage unit 400 (ST103).

The extraction unit 304 decides whether to extract an image (ST104). Here, whether the extraction unit 304 extracts an image can be previously set by the operator. If it is previously set that the extraction unit 304 extracts an image, by referring to the relevant information table 403, the extraction unit 304 extracts the image corresponding to an event ID of the event (acquired at ST102) from the image data 401 (ST105). Here, based on a relevant range corresponding to each event in the relevant information table 403, the extraction unit 304 extracts images belonging to the relevant range. Specifically, on the basis of occurrence timing of the event, the extraction unit 304 extracts images of a period prescribed in the relevant range.

The extraction unit 304 generates information which image data of the extracted images are corresponded with the event ID of the event (acquired at ST102), and stores this information as extracted information 404 into the storage unit 400 (ST106). Then, the extraction unit 304 deletes all images except for the extracted images (ST107).

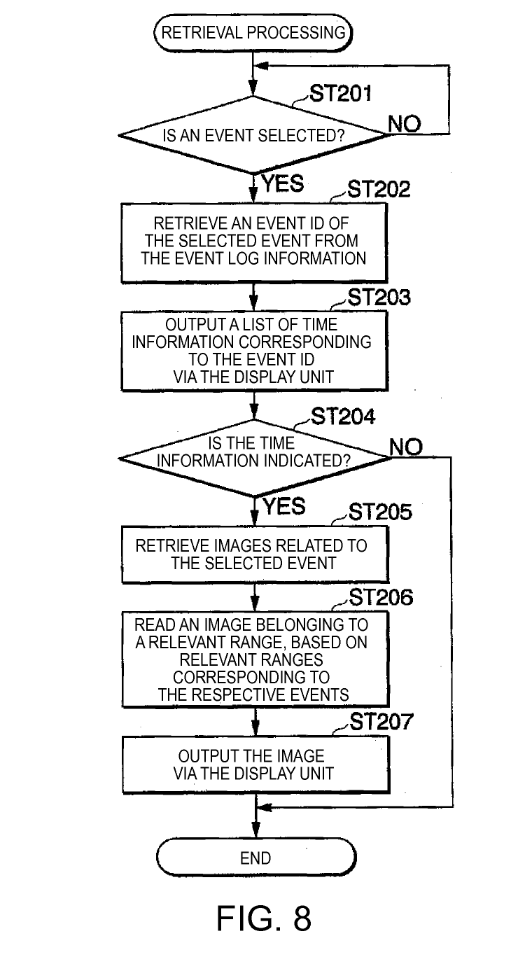

Next, by referring to FIG. 8, retrieval processing by the central control unit 110 is explained. FIG. 8 is a flow chart of one example of the retrieval processing by the central control unit 110. In the central control unit 110, the image retrieval unit 305 decides whether an event as a retrieval target is selected via the operation unit 102 (ST201). If the event as the retrieval target is already selected, by referring to the storage unit 400, the image retrieval unit 305 retrieves an event ID of the selected event from the event log information 402 (ST202). For example, when the event ID “01” is indicated via the operation unit 102, by referring to the event log information 402, the image retrieval unit 305 extracts all of time information corresponding to the event ID “01”. The image retrieval unit 305 reads time information corresponding to the event ID (acquired by retrieving) from the event log information 402, and makes the display unit 103 output a list of the read time information (ST203).

Next, the image retrieval unit 305 decides whether time information as a retrieval target is selected from the list by the operation unit 102 (ST204). If the time information as the retrieval target is already selected, by referring to the storage unit 400, the image retrieval unit 305 retrieves images related to the selected time information (ST205). Specifically, on the basis of occurrence timing of the selected event, the image retrieval unit 305 extracts images of a period prescribed in a relevant range of the event.

For example, by referring to the relevant information table 403, the image retrieval unit 305 acquires camera IDs “A˜C” and the relevant range “from error-occurrence to error-cancellation” corresponding to the event ID “01”. From the image data 401 stored in the storage unit 400, among image data scanned by the cameras 201˜203 represented by camera IDs “A˜C”, the image retrieval unit 305 extracts image data scanned in a period from an error-occurrence time to an error-cancellation time (represented by the time information selected at ST204). Here, a predetermined event ID is assigned to the error-cancellation. Accordingly, the image retrieval unit 305 can acquire time information (i.e., error-cancellation time) corresponding to an event ID of error-cancellation from the event log information 402.

The image retrieval unit 305 reads images acquired by retrieving (ST206). Namely, the image retrieval unit 305 reads images belonging to the relevant range from the storage unit 400, based on the relevant range corresponding to each event in the relevant information table 403. The image retrieval unit 305 makes the display unit 103 output the images (ST207).

In above-mentioned embodiments, the cameras 201˜203 are located at outside of the paper sheets processing apparatus 100. However, location of the cameras is not limited to this. The cameras 201˜203 may be located at inside of the paper sheets processing apparatus 100. For example, the cameras may be located at a connection part between the first unit 111 and the second unit 112, the strapping unit 115a˜115d of each denomination, the transport path of banknotes, or an entrance part into the shredding unit 117.

The camera (located at inside of the paper sheets processing apparatus 100) can scan a banknote transported inside of the paper sheets processing apparatus 100, a banknote jammed on the way therein, and a video of the device. While the banknote is passed through the detection unit 113, if decision result by the detection unit 113 is an unfit note, large skew/slide or a ted banknote, there are fears that the banknote is remained in or escaped from the apparatus 100. In this case, by recording a video of inside of the paper sheets processing apparatus 100, when shortage of banknotes has occurred, the video can be retrieved based on the decision result of the detection unit 113. Here, an event based on the decision result of the detection unit 113 may be set.

In above-mentioned embodiments, the storage unit 400 is incorporated into the paper sheets processing apparatus 100. However, location of the storage unit 400 is not limited to this. The storage unit 400 may be set to a computer outside of the paper sheets processing apparatus 100. Furthermore, the image acquisition unit 301, the event information acquisition unit 303, the extraction unit 304, and the image retrieval unit 305, may be set to the computer outside of the paper sheets processing apparatus 100.

In above-mentioned embodiments, the event information is stored as the event log information in the storage unit 400. However, the event log information may not be stored therein. For example, the extraction unit 304 may write an event ID corresponding to the event information into additional information of the extracted image data.

In above-mentioned embodiments, the time information may be information representing time when the image is scanned or when the event has occurred. A clock or numbering information may be used as the time information.

In above-mentioned embodiments, the extraction unit 304 makes the storage unit 400 store the extracted information. However, the extracted information may not be stored therein. For example, the extraction unit 304 may send the extracted information to a host computer connected via a network. In this case, additional information of images scanned by the camera includes a device number of the paper sheets processing apparatus 100.

Furthermore, in above-mentioned embodiments, the image retrieval unit 305 outputs the retrieval result to the display unit 103. However, the retrieval result may not be outputted to the display unit 103. For example, the image retrieval unit 305 may send the retrieval result to a host computer connected via a network, and make the host computer output the retrieval result. As a result, a plurality of paper sheets processing apparatuses controlled by the host computer can be managed by confirming a video of each event.

In above-mentioned embodiments, the number of modules equipped with the strapping unit 115 is not limited to four (115a˜115d). In case of necessity, the number of modules can be increased or decreased, and a type of modules can be variously selected. For example, one strapping unit 115 may be prepared.

In above-mentioned embodiments, the paper sheets processing apparatus 100 can count the number of banknotes for each bundle of a plurality of paper sheets by using batch cards. However, the batch cards may not be used.

In above-mentioned embodiments, paper sheets processed by the paper sheets processing apparatus 100 are not limited to banknotes. For example, the paper sheets may be game cards or securities.

In above-mentioned embodiments, the paper sheets processing apparatus 100 is located at a place (Hereinafter, it is called “a cash center”) to treat cashes, for example, a bank, a cash transport company or a casino, and can be used for monitoring the operator's injustice operation or injustice action (for the paper sheets processing apparatus 100). In the cash center, a statement amount is mentioned in a cash baggage carried by a customer, and matched with the processing result of the paper sheets processing apparatus 100. Here, if the statement amount is not matched with the processing result, by acquiring images based on an event occurred at the paper sheets processing apparatus 100, the images having possibility to find the operator's injustice operation or injustice action (for the paper sheets processing apparatus 100) can be easily confirmed.

In conventional technique, by freely using event logs of the paper sheets processing apparatus 100 and videos recorded by cameras, a person must work to retroact the reason of mismatch. On the other hand, in the paper sheets processing apparatus 100 of the present embodiment, information able to simply acquire images having possibility to find the operator's injustice operation or injustice action (for the paper sheets processing apparatus 100) is stored in the storage unit 400. Accordingly, by using this information, the person's retroactive working can be supported.

According to at least one of above-mentioned embodiments, from images scanned by the cameras 201˜203, the image retrieval unit 305 retrieves an image corresponding to an event indicated via the operation unit 102. By this component, from the images scanned by the cameras 201˜203, necessary images can be suitably selected for each indicated event.

Furthermore, according to at least one of above-mentioned embodiments, the extraction unit 304 extracts images related to the event from a plurality of images, makes the storage unit 400 store the extracted images and the event information correspondingly, and deletes images except for the extracted images. By this component, a capacity of image data stored in the storage unit 400 can be deleted, and the storage unit 400 can be effectively utilized.

Furthermore, according to at least one of above-mentioned embodiments, the event information acquisition unit 303 acquires event information of an event occurred at the paper sheets processing apparatus 100. As the event, for example, an error has occurred at the paper sheets processing apparatus 100, an opening/closing part (covers 105a˜105d) equipped with the paper sheets processing apparatus 100 is opened, and processing by the paper sheets processing apparatus 100 is stopped. The event information acquisition unit 303 acquires at least one of above-mentioned events. By this component, in the case of necessary to confirm scanned images in the paper sheets processing apparatus 100, these images can be acquired.

Furthermore, according to at least one of above-mentioned embodiments, based on a type of an event, it can be decided whether a video after the event has occurred is only regarded as the relevant range or whether videos before and after the event has occurred are regarded as the relevant range. Furthermore, duration of a period of the relevant range can be set for each event. By this component, as images necessary to be confirmed in the paper sheets processing apparatus 100, a video scanned in the necessary period can be acquired. Here, even if information cannot be sufficiently understood from only one image, by confirming videos scanned in some period, a flow of the operator's operation and a flow of processing by the paper sheets processing apparatus 100 can be confirmed.

While certain embodiments have been described, these embodiments have been presented by way of examples only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A system for processing paper sheets, comprising:
an image acquisition unit that acquires a plurality of images by at least one camera scanning a predetermined position of a paper sheets processing apparatus, the at least one camera being located around the paper sheets processing apparatus;
an event information acquisition unit that acquires an event information related to an event occurred in the paper sheets processing apparatus;
an operation unit that accepts an operation indicating an event, based on the event information; and
an image retrieval unit that retrieves at least one image corresponding to the event indicated by the operation, from the plurality of images, and outputs the at least one image.

2. The system according to claim 1, further comprising:
an extraction unit that extracts images related to the event from the plurality of images, stores the extracted images and the event information correspondingly into a storage unit, and deletes images except for the extracted image from the plurality of images.

3. The system according to claim 1, wherein
the event information acquisition unit acquires the event information related to at least one event among events including
an error has occurred in the paper sheets processing apparatus,
an opening/closing part equipped with the paper sheets processing apparatus is opened, and
a processing by the paper sheets processing apparatus is stopped.

4. The system according to claim 1, wherein
the image retrieval unit outputs images scanned in a period corresponding to a type of the event indicated by the operation, on the basis of a timing when the event has occurred.

5. An apparatus for processing paper sheets, comprising:
at least one camera located at an inside of the apparatus;
an image acquisition unit that acquires a plurality of images by the at least one camera scanning a predetermined position of the inside of the apparatus;
an event information acquisition unit that acquires an event information related to an event occurred in the apparatus;
an operation unit that accepts an operation indicating an event, based on the event information;
an image retrieval unit that retrieves at least one image corresponding to the event indicated by the operation, from the plurality of images; and
a display unit that outputs the at least one image.

6. A system for processing cashes, comprising:
a cash processing apparatus that detects banknotes;
a CPU connected to the cash processing apparatus; and
an operation unit connected to the cash processing apparatus;
wherein the CPU includes
an image acquisition unit that acquires a plurality of images by at least one camera located around the cash processing apparatus;
an event information acquisition unit that acquires an event information related to an event occurred in the cash processing apparatus; and
an extraction unit that associates at least one of the plurality of images with the event information corresponding to the at least one.

7. The system according to claim 6, wherein
the event information acquisition unit notifies the operation unit of the event information.

8. The system according to claim 7, wherein
the operation unit accepts an operation indicating an event, based on the event information.

9. The system according to claim 6, wherein
the extraction unit extracts images related to the event from the plurality of images, stores the extracted images and the event information correspondingly into a storage unit, and deletes images except for the extracted images from the plurality of images.

10. The system according to claim 6, wherein
the event information acquisition unit acquires the event information related to at least one event among events including
an error has occurred in the cash processing apparatus,
an opening/closing part equipped with the cash processing apparatus is opened, and
a processing by the cash processing apparatus is stopped.

11. The system according to claim 8, further comprising:
an image retrieval unit that retrieves at least one image corresponding to the event indicated by the operation, from the plurality of images, and outputs the at least one image.

12. The system according to claim 11, wherein
the image retrieval unit outputs images scanned in a period corresponding to a type of the event indicated by the operation, on the basis of a timing when the event has occurred.
